(19) United States
(12) Patent Application Publication
(10) Pub. No.: US 2018/0310171 A1
(43) Pub. Date: Oct. 25, 2018

(54) INTERACTIVE CHALLENGE FOR ACCESSING A RESOURCE

(71) Applicant: Facebook, Inc., Menlo Park, CA (US)

(72) Inventors: Simon Whitaker, Bicester (GB); Ludovic Fardel, London (GB); Felix Leupold, London (GB); Alan Philip Sutton, Paddock Wood (GB); Sebastian Felix Oberste-Vorth, London (GB); Rahul Parsani, London (GB)

(21) Appl. No.: 15/492,768

(22) Filed: Apr. 20, 2017

(51) Int. Cl. H04W 12/06; H04W 12/08; G06F 3/0488; G06F 3/0346; G06F 3/01; G06F 3/16

(52) U.S. Cl. CPC H04W 12/06; H04W 12/08; G06F 3/04883; G06F 2221/2103; G06F 3/012; G06F 3/167; G06F 2221/2133; G06F 3/0346

(57) ABSTRACT

Methods, systems, computer-readable media, and apparatuses for interactive challenges for accessing a resource are presented. In some embodiments, a method may include presenting a challenge requesting the performance of a specific motion. The method may also include capturing sensor data generated by one or more sensors associated with a mobile device as a result of one or more actions performed by a user in response to the challenge. The method may additionally include determining whether the specific motion was performed by comparing the captured sensor data to reference data associated with the requested specific motion. The method may further include indicating whether the challenge was satisfied based at least in part on the determining.

### BACKGROUND

Aspects of the disclosure relate to an interactive challenge for accessing a resource. Challenge-response tests are often used in computing to determine whether or not a user is human. Many reasons exist for ensuring that the user is human and not a computer or a robot. For example, challenge-response tests may be used to thwart spam and automated extraction of data from websites. Generally, computers or robots are not capable of solving challenge-response tests because the provided challenge may typically only be understood and solved by a human. A popular challenge-response test is a CAPTCHA, a backronym for “Completely Automated Public Turing test to tell Computers and Humans Apart.” CAPTCHAs usually are generated by distorting an image with text/numbers and asking the user to entry the text/numbers as shown in the distorted image, or by presenting a number of images and asking the user to select one or more of the images containing a particular object. CAPTCHAs are usually generated in such a way that any OCR (optical character recognition) or other AI (artificial intelligence) technology fails, and only a human eye can read and make sense of the challenge. CAPTCHAs have proven to be successful as there are still no good automated captcha solving algorithms.

While CAPTCHAs are easy to use by a user on computing devices with large screens (e.g., desktop PCs and laptops), they are inherently difficult to use by a user using a computing device with a limited display size (e.g., mobile phones and tablets). For example, entering text via a finger on a mobile computing device is error prone and can make it difficult for a user to provide a correct response to the CAPTCHA challenge. This can result in a frustrated user experience.

Accordingly, a need exists for an improved challenge-response mechanism on mobile computing devices.

### BRIEF SUMMARY

Certain embodiments are described that provide for an interactive challenge for accessing a resource. Specifically, embodiments are described that provide for an interactive challenge-response test to a user using a mobile device. An example of a challenge-response test is a captcha. The inputs provided by the user to the challenge are then used to determine whether a user is a human or an automated process/script (e.g., a robot). Given the limited real estate on a mobile device and the difficulty to type, traditional captchas used for desktop environments are difficult and frustrating to use on mobile devices. A number of improved and new captcha techniques are disclosed and specifically geared for use on mobile devices. These techniques include providing captchas that are based upon data sensed or captured by a mobile device. For example, captchas may be based upon motion data captured by an accelerometer of the mobile device, audio/video/image data captured by a camera of the mobile device, fingerprint data, data captured based upon user finger interactions with a captcha, and the like. For example, the captcha may be a certain motion (e.g., draw a shape using the mobile device, move the mobile device according to a rhythm, move the mobile device proximate to an object (e.g., user's body), a mini-game, or by detecting whether mobile device is held by hand).

Accelerometer data generated by the motion may then be used to determine if the captcha challenge is satisfied. As another example, a captcha may be based upon video information captured by a mobile device. For example, a user may be made to perform a facial movement (e.g. make an ‘ooo’ and ‘aah’ sound) and the associated video data captured by the mobile device in conjunction with a face tracking application that can recognize whether the user has performed the particular facial movement instructed by the captcha. Captchas may also be based upon interaction with images (e.g., pinch zoom a photo to blow up a certain object in image, rotate image, tap object in a randomized location on the mobile device screen, etc.); biometric information (e.g., fingerprint detection that may be used to determine whether this is a human fingerprint provided to the fingerprint sensor); presenting multiple advertisements to a user and asking the user to pick the “best” ad and determining whether the user selected the correct ad based upon, for example, ad rankings; swipe actions to select relevant choices (e.g., photos of friends) and determining whether the swipe is typical of a human swipe or typical of an automated swipe.

In some embodiments, a method may include presenting a challenge requesting the performance of a specific motion. The method may also include capturing sensor data generated by one or more sensors associated with a mobile device as a result of one or more actions performed by a user in response to the challenge. The method may additionally include determining whether the specific motion was performed by comparing the captured sensor data to reference data associated with the requested specific motion. The method may further include indicating whether the challenge was satisfied based at least in part on the determining.

In some embodiments, the one or more sensors may include at least one of an accelerometer or a proximity sensor.

In some embodiments, determining whether the specific motion was performed may include determining, based upon the captured sensor data, whether the mobile device is being held by a human.

In some embodiments, the specific motion requested by the challenge may include at least one of placing the mobile device proximate to the user's body, moving the mobile device in a particular shape, making a motion with the mobile devices while participating in an interactive game presented to the user, moving the mobile device in a specific rhythm, swiping across a display of the mobile device with a user extremity, or performing a facial movement, and wherein the sensor data comprises captured frames of the performed facial movement with a camera of the mobile device.

In some embodiments, the method may also include presenting the user with information, wherein swiping across the display of the mobile device with the user extremity comprises swiping in a first direction if the presented information is recognized by the user and swiping in a second direction if the presented information is not recognized by the user.

In some embodiments, the method may also include receiving a request to provide the challenge, wherein the indicating comprises providing an indication whether the challenge was satisfied to a source of the request.

In some embodiments, the request may be received from a social network application.

In some embodiments, the challenge may be presented before allowing access to a resource, wherein determining whether the specific motion was performed may include determining that the specific motion was performed and the challenge was satisfied, and wherein the method may further include allowing access to the resource upon determining that the challenge was satisfied.

In some embodiments, the challenge may be presented in response to determining that a content item attempted to be posted by the user to a social network environment meets a spam threshold, and the method may further include allowing the content item to be posted by the user to the social network environment upon determining whether the specific motion was performed.

In some embodiments, the specific motion requested by the challenge may include speaking one or more words, and the sensor data may include captured audio of the spoken one or more words with a microphone of the mobile device.

In some embodiments, a mobile device may include a display, a processor, a challenge subsystem, and one or more sensors coupled to the processor. The challenge subsystem may be configured to present a challenge, via the display, requesting the performance of a specific motion. The one or more sensors may be configured to generate sensor data as a result of one or more actions performed by a user in response to the challenge. The processor may be configured to determine whether the specific motion was performed by comparing the captured sensor data to reference data associated with the requested specific motion, and indicate whether the challenge was satisfied based at least in part on the determining.

In some embodiments, one or more non-transitory computer-readable media may store computer-executable instructions that, when executed, may cause one or more computing devices to present a challenge requesting the performance of a specific motion, capture sensor data generated by one or more sensors associated with a mobile device as a result of one or more actions performed by a user in response to the challenge, determine whether the specific motion was performed by comparing the captured sensor data to reference data associated with the requested specific motion; and indicate whether the challenge was satisfied based at least in part on the determining.

### BRIEF DESCRIPTION OF THE DRAWINGS

Aspects of the disclosure are illustrated by way of example. In the accompanying figures, like reference numbers indicate similar elements.

FIG. 1 illustrates a simplified diagram of a mobile device and server computer that may incorporate one or more embodiments;

FIG. 2 is a flowchart illustrating a process for providing an interactive challenge to a user of a mobile device, in accordance with some embodiments;

FIG. 3 illustrates a user attempting to post a content item to a social network environment that requires passing an interactive challenge prior to allowing the content to be posted, in accordance with some embodiments;

FIG. 4 illustrates a user attempting to access an account settings page, within the social network environment, that requires passing an interactive challenge prior to access being allowed, in accordance with some embodiments;

FIG. 5 illustrates an interactive challenge involving drawing a shape with a mobile device, in accordance with some embodiments;

FIG. 6 illustrates an interactive challenge involving shaking to a certain rhythm with the mobile device, in accordance with some embodiments;

FIG. 7 illustrates a user holding a mobile device in response to a challenge presented to a user, in accordance with some embodiments;

FIG. 8 illustrates an interactive challenge involving playing a “mini-game” with the mobile device, in accordance with some embodiments;

FIG. 9 illustrates an interactive challenge involving making a certain facial expression in front of a mobile device, in accordance with some embodiments;

FIG. 10 illustrates an interactive challenge involving interactions with a presented image, in accordance with some embodiments;

FIG. 11 illustrates another interactive challenge involving interactions with a presented image, in accordance with some embodiments; and

FIG. 12 illustrates an example of a computing system in which one or more embodiments may be implemented.

### DETAILED DESCRIPTION

Several illustrative embodiments will now be described with respect to the accompanying drawings, which form a part hereof. While particular embodiments, in which one or more aspects of the disclosure may be implemented, are described below, other embodiments may be used and various modifications may be made without departing from the scope of the disclosure or the spirit of the appended claims.

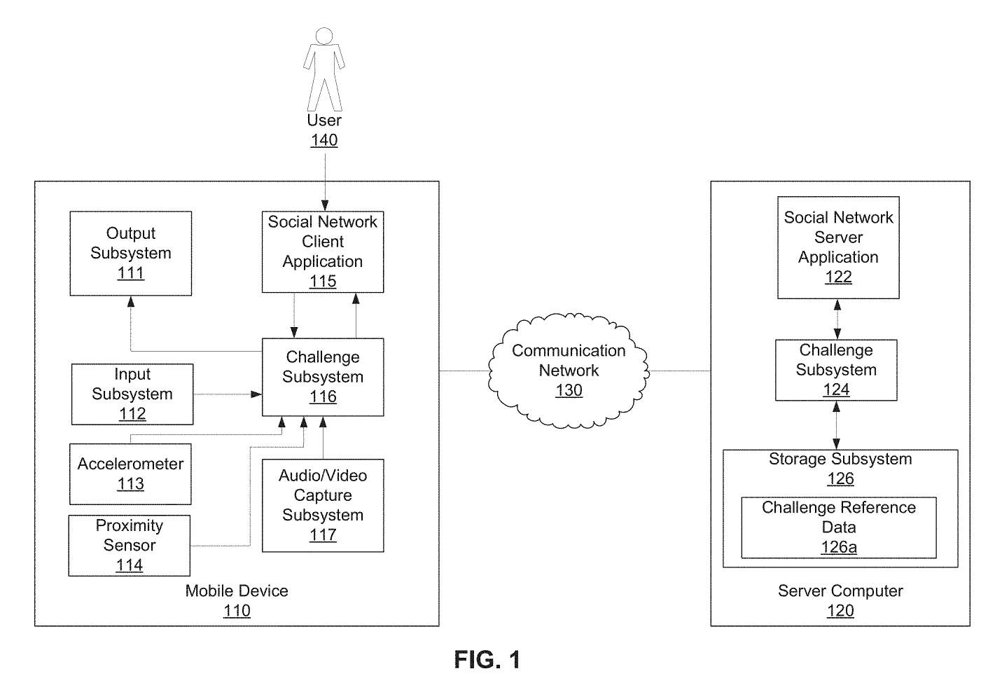

FIG. 1 illustrates a simplified diagram of a mobile device 110 and server computer 120 that may incorporate one or more embodiments. The mobile device 110 and server computer 120 may communicate with each other via communication network 130. One example of communication network 130 is the Internet.

The mobile device 110 may include output subsystem 111, input subsystem 112, accelerometer 113, proximity sensor 114, social network client application 115, challenge subsystem 116, and audio/video capture subsystem 117, which all may be coupled to a processor (not shown). The processor may execute the various applications and subsystems that are part of the mobile device 110.

Output subsystem 111 may be configured to output or transmit data to an external device or apparatus. For example, output subsystem 111 may transmit data from mobile device 110 to server computer 120 communication network 130. Output subsystem 111 may also transmit data to a display coupled to mobile device 110 that is meant to be presented to user 140. For example, output subsystem 111 may provide data pertaining to a challenge request to the display so that the display can present the data to the user 140.

Input subsystem 112 may be configured to receive data from an external device or a user. For example, input subsystem 112 ma receive data from server computer 120 via communication network 130. In another example, input subsystem 112 may receive touch, voice, video, or motion input from the user 140.

Accelerometer 113 may be configured to obtain sensor data used to measure motion input from the mobile device 110. For example, accelerometer 113 may obtain sensor data indicative of the user 140 moving the mobile device 110 in a certain direction.

Proximity sensor 114 may be configured to detect the presence of objects nearby to the mobile device 110 without any physical contact. For example, the proximity sensor 114 may be configured to obtain sensor data indicative of whether the mobile device 110 is being held within a certain distance to the user's 140 body.

Social network client application 115 may be configured to, when executed by the processor, allow the user 140 to access a social network environment via mobile device 110. For example, a user may choose to launch the social network client application 115 by selecting an icon associated with the application via input subsystem 112. The social network client application 115 may communicate with the server computer 120, via communication network 130, in order to access the social network environment. The server computer 120 may grant the user access to the social network environment via the social network server application 122. The user may use input subsystem 112 to interact with various elements within the social network client application 115. Examples of a social network client application 115 include, but is not limited to, a web browser, a mobile application, etc.

Challenge subsystem 116 may be configured to, when executed by the processor, determine and present a challenge to user 140, and receive and process a response to the challenge.

Audio/video capture subsystem 117 may be configured to capture audio/video data. For example, the audio/video capture subsystem 117 may capture the user's 140 voice via a microphone or may capture an image/video of the user's 140 face via a camera.

The server computer 120 may include social network server application 122, challenge subsystem 124, and storage subsystem 126, which all may be coupled to a processor (not shown). The processor may execute the various applications and subsystems that are part of the server computer 120.

Social network server application 122 may be configured to, when executed by the processor, allow users to participate in a networking community in which users network through friends, friends of friends, and so forth. A user may create a personal profile. The user can browse and search through all of the users connected to a user through networks of friends or view profiles associated with businesses, establishments, places, etc. A user can also view photos and profiles, see how the user is connected to other users, send messages, ask friends for introductions, or suggest matches between friends or even friends of friends. The social network application can be used for all types of social networking. A user 140 may access the social network via a mobile device 110 (e.g., personal computer, smartphone, tablet, etc.) that executes a social network client application 115 which accesses and interfaces with the social networking server application 122 on the server computer 120.

Challenge subsystem 124 may be configured to, when executed by the processor, determine a challenge that should be presented to the user 140, and receive and process a response to the challenge.

Storage subsystem 126 may be configured to store data. In one example, the storage subsystem 126 may challenge reference data 126a. The challenge reference data 126a may be reference data associated with a challenge that may be presented to the user 140. The challenge reference data 126a may be compared to, by the challenge subsystem 124, sensor data captured in response to a presented challenge in order to determine whether the user 140 has successfully responded to the presented challenge.

The following description illustrates how the mobile device 110 and server computer 120 may interact with each other in order to implement the interactive challenge process described above. The social network server application 122 may send a challenge request to the challenge subsystem 124. The challenge may be requested in response to a user action, such as the user 140 requesting access to a resource within the social network environment, verifying that content posted to the social network environment originated from the user 140, or any other scenario where the social network server application 122 may want to ensure that the user 140 is a human and not a robot or automated script.

The challenge subsystem 124 on the server computer 120 may then determine a specific challenge to be presented to the user by the mobile device 110. For example, the specific challenge may be based upon motion data captured by the accelerometer 113, audio/video/image data captured by the audio/video capture subsystem 117, fingerprint data, data captured based upon user finger interactions with the mobile device 110, etc. In some embodiments, specific challenge determined by the challenge subsystem 116 may be defined by the specific resource being accessed by the user 140 within the social network environment. For example, accessing an “account settings” resource within the social network environment may dictate that an audio/video/image based challenge should be presented to the user 140.

In some embodiments, the challenge subsystem 116 on the mobile device 110 may determine the specific challenge to be presented to the user 140, instead of the challenge subsystem 124 on the server computer 120 doing so. The social network server application 122 may send a request to the challenge subsystem 116 on the mobile device 110 to determine and generate a captcha.

Upon determining the challenge to be presented to the user 140, the challenge subsystem 124 on the server computer 120 may send the determined challenge to the challenge subsystem 116 on the mobile device 110. The challenge subsystem 116 on the mobile device 110 may in turn send the determined challenge to the output subsystem 111 for presentation to the user 140. The output subsystem 111 may, for example, present the determined challenge the user 140 via a display of the mobile device 110.

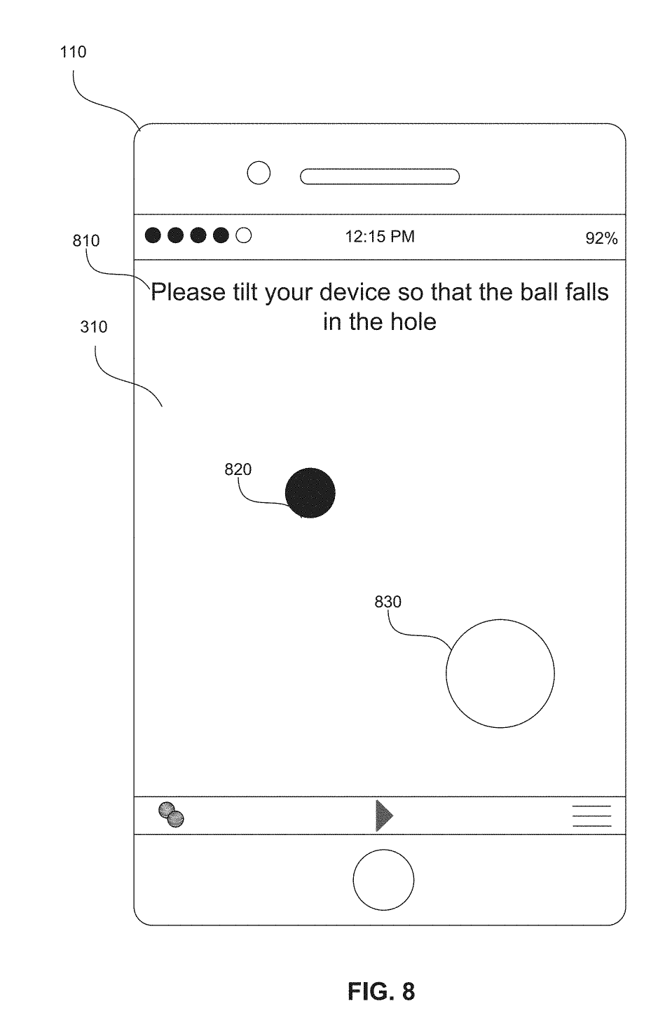

The user 140 may then perform some motion or action in response to the presented challenge. For example, the user 140 may move the mobile device 110 in a “figure 8” motion. In another example, the user 140 may place the mobile device 110 close to his/her chest. In another example, the user 140 may shake the mobile device 110 in accordance with a specific rhythm.

The user motion or action may be captured by one or more sensors within the mobile device 110. For example, the accelerometer 113 may capture sensor data indicating movement of the mobile device 110 (e.g., the “figure 8” motion) and provide the captured sensor data to the challenge subsystem 116. The challenge subsystem 116 on the mobile device 110 may in turn send the captured sensor data to the challenge subsystem 124 on the server computer 120.

The challenge subsystem 124 on the server computer 120 may compare the captured sensor data against the challenge reference data 126a stored within the storage subsystem 126. For example, the reference data may be motion data indicative of a typical “figure 8” motion with a mobile device. The challenge subsystem 124 on the server computer 120 may compare the captured sensor data to see how closely it matches to the challenge reference data 126a. If the captured sensor data and challenge reference data 126a match within a specified threshold, the challenge subsystem 124 may determine that the challenge was passed by the user 140 and provide an indication or result of the passing to the social network client application 115.

Additionally, the social network server application 122 may then grant the user 140 access to the resource 140. For example, the social network server application 122 may allow content that the user 140 wishes to post to the social network environment to be posted to the social network environment upon receiving the challenge passed result from the challenge subsystem 124, which may indicate that the user 140 is a human. In some embodiments, the social network server application 122 may relay the challenge passed indication to the social network client application 115, which may then provide feedback to the user 140 that access was granted to the resource.

In some embodiments, where the challenge subsystem 116 on the mobile device 110 itself determines the specific challenge to be presented to the user 140, the challenge subsystem 116 on the mobile device 110 may also determine whether the challenge was passed by comparing the captured sensor data to challenge reference data stored locally on the mobile device 110.

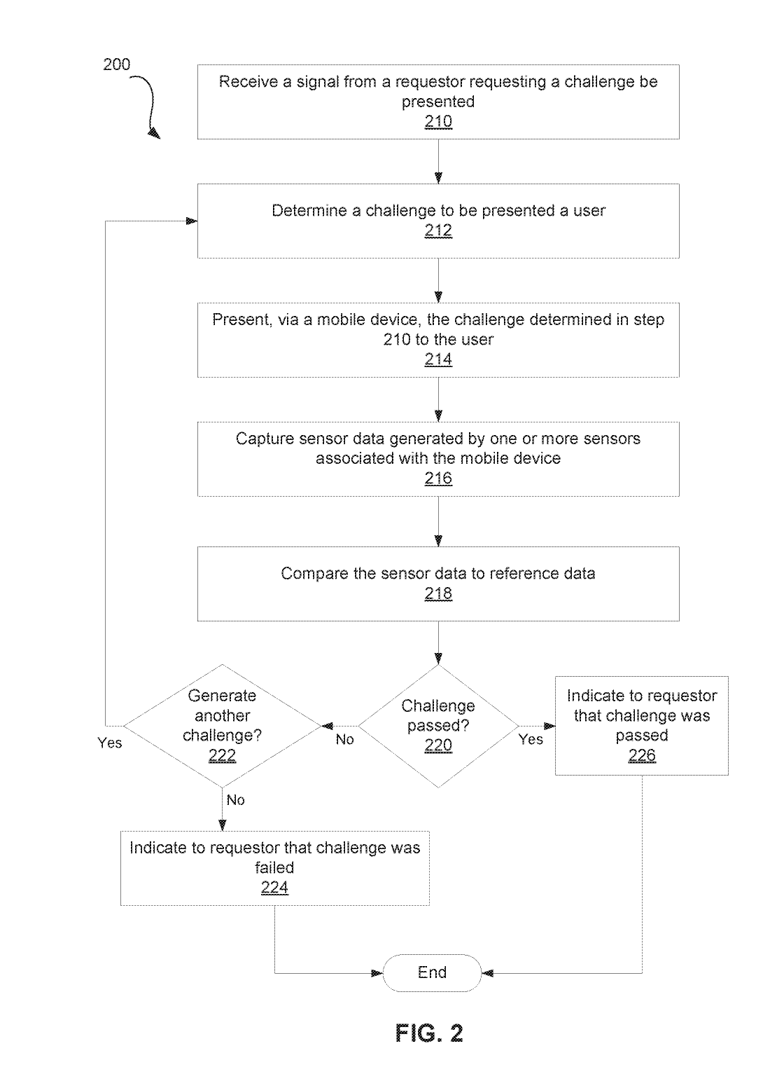

FIG. 2 is a flowchart illustrating a process 200 for providing an interactive challenge to a user of a mobile device. The process 200 begins at step 210.

At step 210, a mobile device may receive a signal from a requestor requesting that a challenge be presented to a user. The requestor may be a social network server application running on a server computer, or plurality of server computers. For example, the social network client application 115 may receive a request, from the social network server application 122, for a challenge to be presented to the user 140.

At step 212, after the mobile device receives a signal from a requestor requesting that a challenge be presented to a user, a challenge to be presented to a user may be determined. In some embodiments, the challenge to be presented to the user may be determined by the challenge subsystem 124 on the server computer 120. The determined challenge may then be transmitted to social network client application 115. The determined challenge may also be transmitted simultaneous to the request in step 210.

In some embodiments, the challenge to be presented to the user may be determined by the challenge subsystem 116 on the mobile device 110.

At step 214, after a challenge to be presented to the user is determined, the determined challenge may be presented, via the mobile device, to the user. For example, after either the challenge subsystem 124 on the server computer 120 or challenge subsystem 116 on the mobile device 110 determine the challenge to be presented to the user, the determined challenge may be provided to the social network client application 115. The social network client application 115 may then display the determined challenge to the user 140, via a display of the mobile device 110. The presented challenge may provide the challenge itself and instructions pertaining to the challenge. For example, the mobile device 110 may display a picture of a “figure-8” and request that the user 140 move the mobile device 110 in the same shape of the “figure-8.”

At step 216, after the challenge is presented to the user, the mobile device 110 may capture sensor data generated by one or more sensors associated with the mobile device 110. For example, the mobile device 110 may capture sensor data using the accelerometer 113, proximity sensor 114, audio/video capture subsystem 117, or any other sensors that may be coupled to the mobile device 110. The sensor data may be captured contemporaneously to the user performing a specific motion or action as instructed by the presented challenge in step 214. For example, if the challenge presented to the user instructs the user to move the mobile device 110 in a specific shape or shake the mobile device according to a specific rhythm, sensor data captured from the accelerometer 113 may be indicative of movement of the mobile device 110 by the user 140. In another example, if the challenge presented to the user instructs the user to move the mobile device 110 proximate to the user's 140 body, sensor data captured by the proximity sensor 114 may be indicative of the mobile device's 110 position proximate to an object. In yet another example, if the challenge presented to the user instructs the user to make a certain facial gesture (e.g., “ooh” and “aah” with the lips), sensor data captured from the audio/video capture subsystem 117 may be indicative of the user's facial movements. In yet another example, if the challenge presented to the user instructs the user to swipe across a display of the mobile device 110 in a certain direction, sensor data captured from the input subsystem 112 may be indicative of the user's swipe across the display of the mobile device 110.

At step 218, after the mobile device 110 captures sensor data generated by one or more sensors associated with the mobile device 110, the captured sensor data is compared to reference data associated with the presented challenge. For example, after capturing the sensor data, the mobile device 110 may transmit the captured sensor data to the server computer 120. The challenge subsystem 124 on the server computer 120 may compare the received captured sensor data to challenge reference data 126a stored within the storage subsystem 126. The challenge reference data 126a may store reference data for a number of different challenges that may be presented to the user 140. For example, the challenge reference data 126a may include reference data of how accelerometer sensor data that is typical of a “figure-8” motion. The challenge subsystem 124 on the server computer 120 may compare the captured accelerometer data while the user 140 was performing the “figure-8” motion with the mobile device 110 to the challenge reference data 126a for the “figure-8” motion.

At step 220, after the captured sensor data is compared to reference data associated with the presented challenge, a determination may be made as to whether the challenge was passed. For example, the challenge subsystem 124 on the server computer 120 may determine whether the challenge was passed by the user 140 based on the comparison of the captured sensor data to the challenge reference data 126a. A determination that the challenge was passed may be made if the captured sensor data matches the challenge reference data 126a within a certain threshold. That is, the captured sensor data need not match the challenge reference data 126a exactly in order for the user's 140 response to the challenge to be considered passing, since there may be slight variations in motions or actions performed by the user 140. If the challenge subsystem 124 on the server computer 120 determines that the challenge was passed by the user 140, the process may continue to step 226. Otherwise, if the challenge subsystem 124 on the server computer 120 determines that the challenge was not passed by the user 140, the process may continue to step 222.

At step 222, if the challenge subsystem 124 on the server computer 120 determines that the user's 140 response did not pass the presented challenge, the challenge subsystem 124 may determine whether another challenge should be generated for the user 140. Whether or not to generate another challenge for the user may be defined by a rule of the social network server application 122. For example, the server network server application 122 may define a rule that the user 140 should be given three chances to provide a successful response to one or more challenges before being denied access to the resource. If it is determined that another challenge should be generated for the user 140, the process may return to step 212 where a new challenge may be determined to be presented to the user. The newly generated challenge may be of the same type or of a different type as the challenge originally presented to the user in step 214. If it is determined that another challenge should not be generated for the user 140, the challenge subsystem 124 on the server computer 120 may indicate to the requestor that the challenge was failed by the user 140 (step 224). For example, the challenge subsystem 124 may send an indication to the social network server application 122 that the user 140 failed the challenge and the social network server application 122 may not provide the user 140 with access to the resource. The social network server application 122 may then indicate to the social network client application 115 that the challenge was not passed by the user 140, and the social network client application 115 may provide feedback to the user 140, via a display of the mobile device 110, that the challenge was failed and access to the resource was denied.

At step 226, if the challenge subsystem 124 on the server computer 120 determines that the user's response did pass the presented challenge, the challenge subsystem 124 may provide an indication to requestor (e.g., the social network server application 122) that the user 140 passed the challenge. In turn, the social network server application 122 may grant the user 140 access to the resource. Additionally, the social network server application 122 may indicate to the social network client application 115 that the challenge was passed by the user 140, and the social network client application 115 may provide feedback to the user 140, via a display of the mobile device 110, that the challenge was passed and access to the resource was granted.

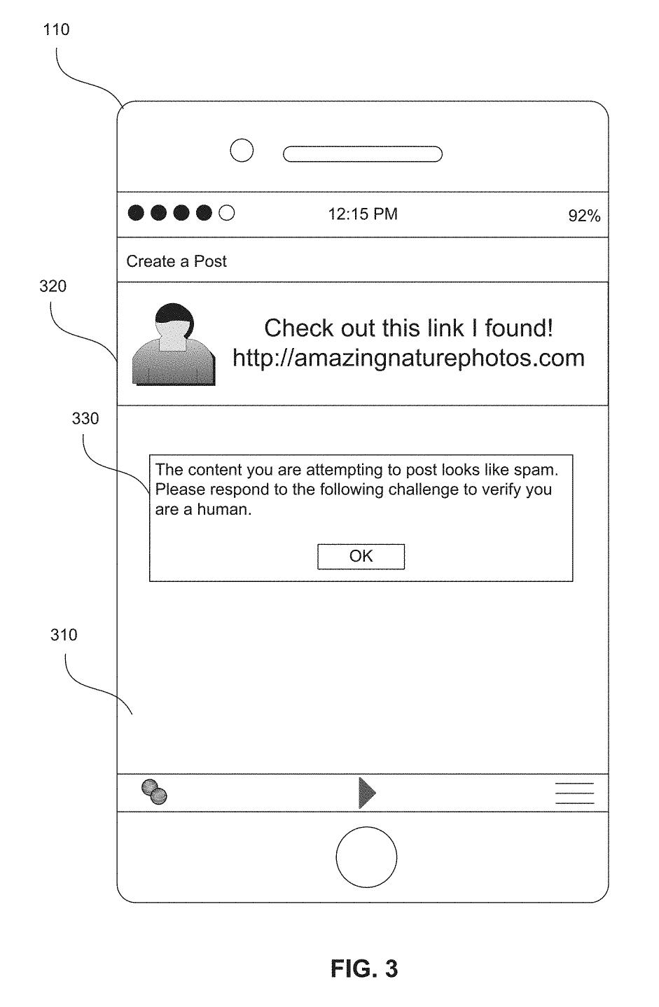

FIG. 3 illustrates a user attempting to post a content item to a social network environment that requires passing an interactive challenge prior to allowing the content to be posted, in accordance with some embodiments. The figure illustrates a mobile device 110 operated by the user 140. The mobile device 110 may execute social network client application 115 in order to access the social network environment. The user 140 may interact with the social network environment via a user interface displayed on display 310 of the mobile device 110.

The user 140 may attempt to post a new content item 320 to the social network environment. In this example, the content item 320 is a link to a website that the user 140 finds to be interesting. For example, the content item 320 attempted to be post by the user states “Check out this link I found! http://amazingnaturephotos.com.” Upon the user 140 attempting to post the content item, the social network server application 122 may make a determination whether the attempted post of the content item meets a spam threshold. In other words, the social network server application 122 may determine whether the attempted post of the content item is such that there may be a likelihood that it is being posted by a computer or robot for spam purposes rather than an actual human being.

The social network server application's 122 determination whether the attempted post of the content item meets a spam threshold may be done via a classifier. The classifier may be trained using various text, links, images, videos, or other content typically posted to the social network environment. In another example, the classifier may be trained based on one or more attributes of content items typically posted to the social network environment. These attributes may include a geolocation of a post, post length, post source device (e.g., mobile device or personal computer), etc. When the user 140 attempts to post the content item to the social network environment, the social network server application 122 may provide the attempted content item post or attributes associated with the post to the classifier as an input, and the classifier may output a class based on the input, the output indicative of whether the attempted content item post meets a spam threshold.

If the social network server application 122 determines that the post attempted content item post meets a spam threshold, the social network client application 115 may provide a notification 330 to the user that the attempted content item post may be spam, and the user will need to respond to a challenge in order to verify that the user is a human. In some embodiments, the notification 330 may not be presented and the challenge may simply be presented to the user after the user attempts to post the content item that meets the spam threshold. Any of the challenges discussed throughout this description may be presented to the user.

In some embodiments, upon attempting to post the content item to the social network environment, and the social network server application 122 making a determination whether the attempted post of the content item meets a spam threshold, the user may be presented with an “appeal this decision” button which may allow the user to appeal the spam determination made by the social network server application 122. In appealing the spam decision, the user may be presented with a challenge. If the user passes the challenge, the user may successfully appeal the spam decision and the content item attempted to be posted by the user may be allowed to be posted to the social network environment.

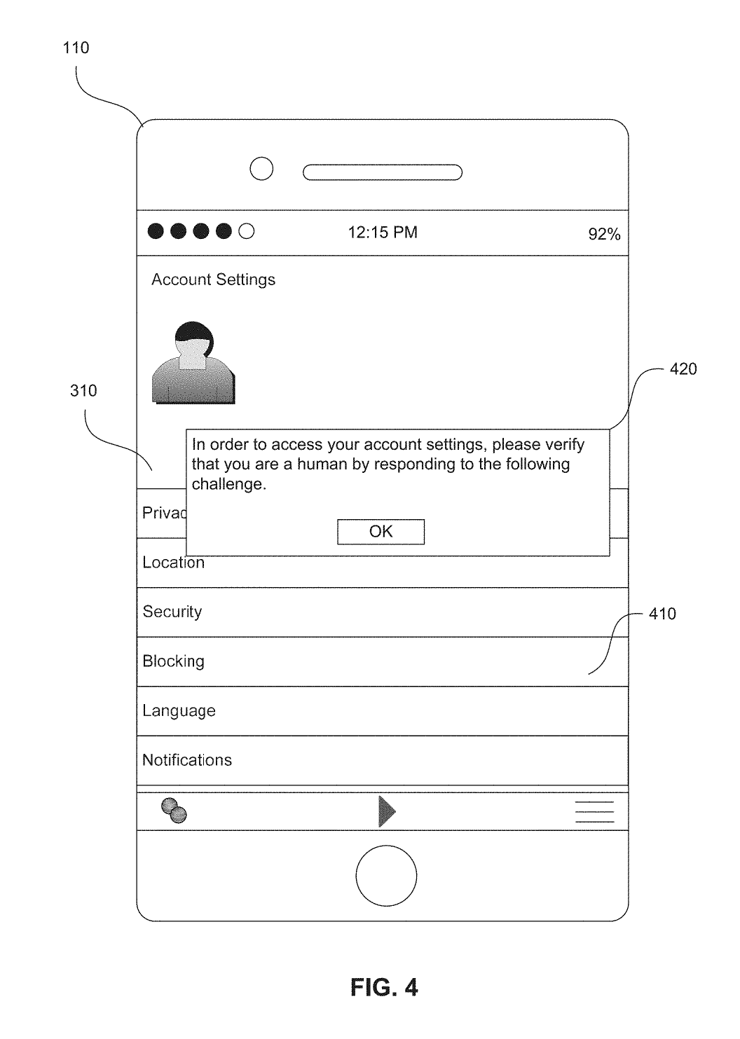

FIG. 4 illustrates a user attempting to access an account settings page, within the social network environment, that requires passing an interactive challenge prior to access being allowed, in accordance with some embodiments. The figure illustrates a mobile device 110 operated by the user 140. The mobile device 110 may execute social network client application 115 in order to access the social network environment. The user 140 may interact with the social network environment via a user interface displayed on display 310 of the mobile device 110.

The user may attempt to access an “account settings” page 410 associated with the user's account within the social network environment. The account settings page may provide the user 140 with access to change settings associated with the user's 140 account. Many of the settings may be sensitive. Upon the user 140 attempting to access the account settings page 410, the social network server application 122 may make a determination whether the attempted access of the account settings page 410 meets a fraud threshold. Since the account settings page 410 provides access to a lot of sensitive information and settings, it may be beneficial to ensure that the user is a human and the attempted access to the account settings page 410 is not fraudulent activity from a robot or computer.

Similar to what is described with respect to FIG. 3, the social network server application's 122 determination whether the attempted access of the account settings page 410 meets a fraud threshold may be done via a classifier. The classifier may be trained based one or more attributes associated with user's accessing an account settings page 410. These attributes may include, but is not limited to, geolocation of the device, time between an initial login and access of the account settings page, time of day, etc. When the user 140 attempts to access the account settings page 410, the social network server application 122 may provide one or more of these attributes to the classifier as an input, and the classifier may output a class based on the input, the output indicative of whether the attempted access of the account settings page 410 meets a fraud threshold.

If the social network server application 122 determines that the user's 140 attempted access at the account settings page 410 meets a fraud threshold, the social network client application 115 may provide a notification 420 to the user that the attempted access requires that the user will need to respond to a challenge before access is granted. In some embodiments, the notification 420 may not be presented and the challenge may simply be presented to the user after the user attempts to access the account settings page 410 and the access meets the fraud threshold. Any of the challenges discussed throughout this description may be presented to the user.

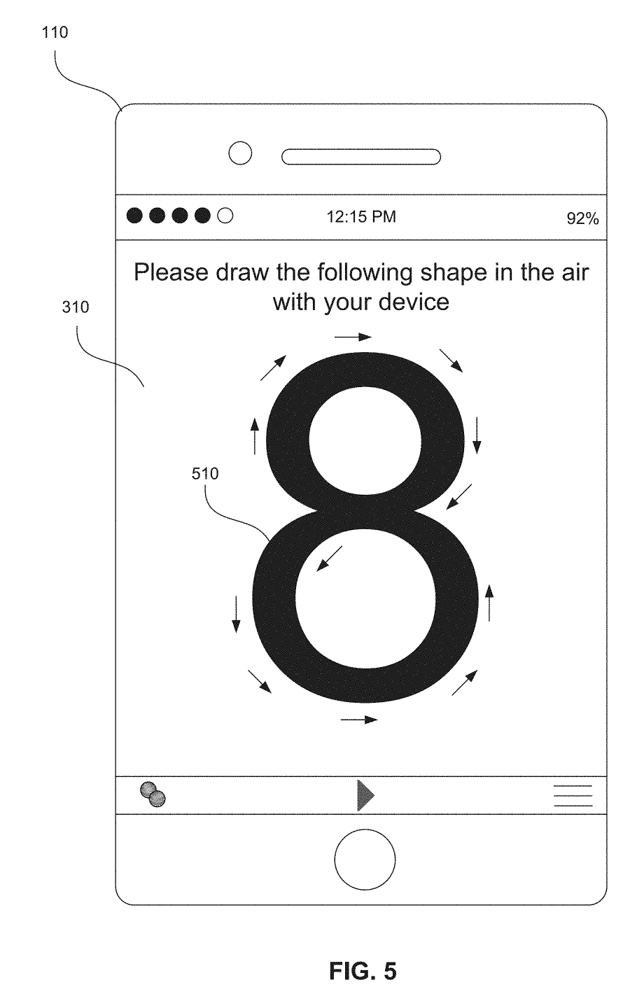

FIG. 5 illustrates an interactive challenge involving drawing a shape with a mobile device, in accordance with some embodiments. The figure shows the challenge 510 being presented on a user interface displayed on the display 310 of the mobile device 110. The challenge 510 displayed illustrates a “figure-8” motion that the user is requested to perform using the mobile device 110. The challenge 510 may be presented to the user 140 prior to granting the user 140 access to a resource, such as allowing the user post a content item or granting the user access to an account settings page as described above. Additionally, the challenge 510 may be presented to the user by the social network client application 115 after receiving a request from the social network server application 122 to do so. The specific challenge may be determined in the fashion described above with respect to FIGS. 1-2. While a “figure-8” motion is illustrated in the figure, any type of shape may be presented to the user 140 as a motion to make using the mobile device 110.

In response to the presented challenge 510, the user 140 may hold the mobile device 110 in either hand and move the mobile device 110 in the air so as to create a “figure-8” shape using the mobile device 110. The accelerometer 113 may capture sensor data while the user is performing the specific motion with the mobile device 110. As described above, the captured sensor data may be compared to the challenge reference data 126a within the storage subsystem 126. The challenge reference data 126a may be accelerometer reference data indicative of moving the mobile device according to the “figure-8” motion. If the captured sensor data and the challenge reference data 126a match within a specific threshold, the user 140 may pass the challenge. Otherwise, if the captured sensor data and the challenge reference data 126a do not match within a specific threshold, the user 140 may not pass the challenge and the user may be presented with another challenge depending on the settings of the social network server application 122. Upon passing the challenge, the user may be granted access to the resource.

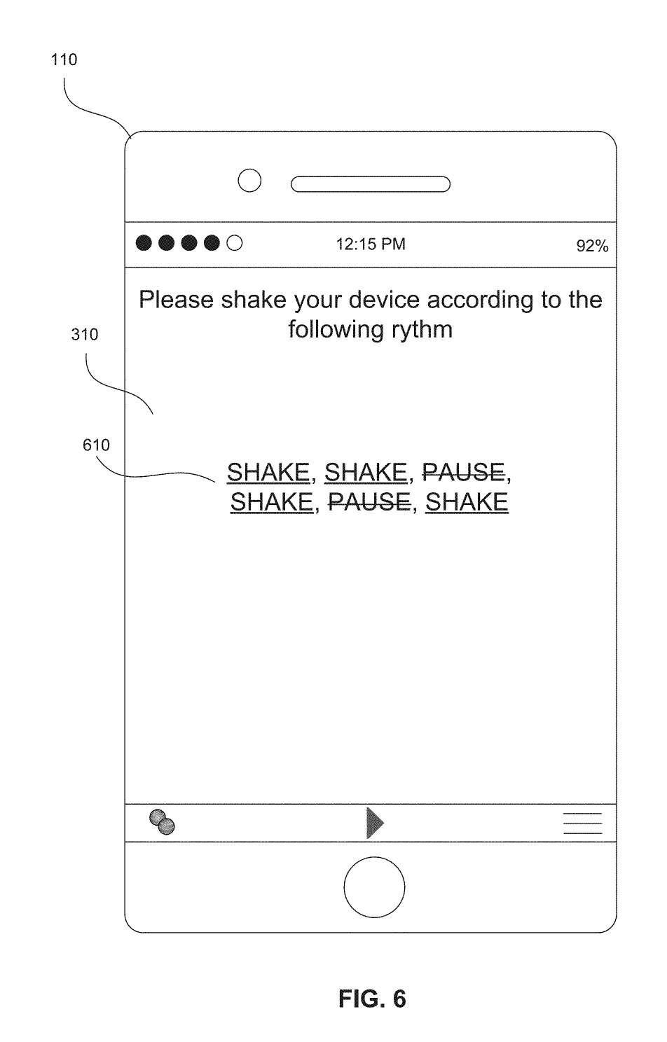

FIG. 6 illustrates an interactive challenge involving shaking to a certain rhythm with the mobile device, in accordance with some embodiments. The figure shows the challenge 610 being presented on a user interface displayed on the display 310 of the mobile device 110. The challenge 610 displayed illustrates a rhythm that the user is requested to perform by shaking the mobile device 110. The challenge 610 may be presented to the user 140 prior to granting the user 140 access to a resource, such as allowing the user post a content item or granting the user access to an account settings page as described above. Additionally, the challenge 610 may be presented to the user by the social network client application 115 after receiving a request from the social network server application 122 to do so. The specific challenge may be determined in the fashion described above with respect to FIGS. 1-2. While the rhythm “shake, shake, pause, shake, pause, shake” is illustrated in the figure, any rhythm may be presented to the user 140 to perform using the mobile device 110.

In response to the presented challenge 610, the user 140 may shake the mobile device 110 in either hand according to the presented rhythm. For example, the user may shake the device twice, pause for one second, shake the device again, pause for another second, and shake the device one more time. The accelerometer 113 may capture sensor data while the user is shaking the mobile device 110 according to the specific rhythm presented. As described above, the captured sensor data may be compared to the challenge reference data 126a within the storage subsystem 126. The challenge reference data 126a may be accelerometer reference data indicative of shaking the device according to the presented rhythm. If the captured sensor data and the challenge reference data 126a match within a specific threshold, the user 140 may pass the challenge. Otherwise, if the captured sensor data and the challenge reference data 126a do not match within a specific threshold, the user 140 may not pass the challenge and the user may be presented with another challenge depending on the settings of the social network server application 122. Upon passing the challenge, the user may be granted access to the resource.

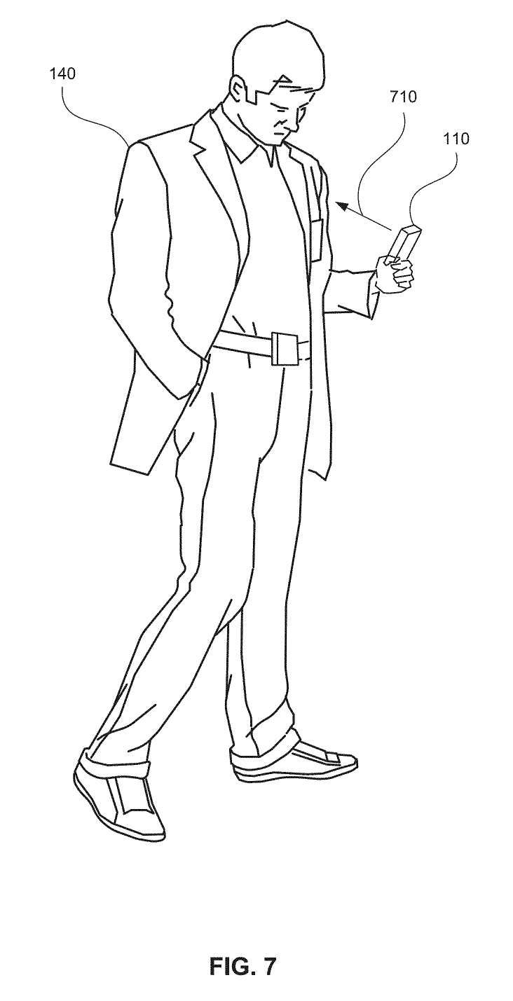

FIG. 7 illustrates a user holding a mobile device in response to a challenge presented to a user, in accordance with some embodiments. In some embodiments, the presented challenge may request the user 140 to simply hold the mobile device 110 with either hand. The challenge may be presented to the user 140 using a user interface displayed on a display of the mobile device 110. For example, the challenge presented may display on the mobile device 110 “Please hold your device in your right hand for three seconds.”

In response to the presented challenge, the user may hold the mobile device 110 in his/her right hand for three seconds, as instructed. The accelerometer 113 may capture sensor data while the user is holding the mobile device 110 in his/her hand. As described above, the captured sensor data may be compared to the challenge reference data 126a within the storage subsystem 126. The challenge reference data 126a may be accelerometer reference data indicative of how a human may naturally hold a mobile device 110. If the captured sensor data and the challenge reference data 126a match within a specific threshold, the user 140 may pass the challenge. Otherwise, if the captured sensor data and the challenge reference data 126a do not match within a specific threshold, the user 140 may not pass the challenge and the user may be presented with another challenge depending on the settings of the social network server application 122. Upon passing the challenge, the user may be granted access to the resource.

In some embodiments, the presented challenge may request the user 140 to move the mobile device 110 proximate to the user's 140 body. For example, the challenge presented may display on the mobile device 110 “Please move the device toward your chest.” In response, the user 140 may bring the mobile device 110 toward his/her chest, as illustrated by motion 710. The accelerometer 113 may capture sensor data while the user is bringing the mobile device 110 toward his/her chest, as illustrated by motion 710. As described above, the captured sensor data may be compared to the challenge reference data 126a within the storage subsystem 126. The challenge reference data 126a may be proximity sensor reference data indicative of the mobile device 110 being proximate to an object. Additionally, the challenge reference data 126a may also include accelerometer data indicative of the mobile device 110 being moved across a plane. The combination of the proximity sensor data and the accelerometer data may make up the challenge reference data 126a. If the captured sensor data and the challenge reference data 126a match within a specific threshold, the user 140 may pass the challenge. Otherwise, if the captured sensor data and the challenge reference data 126a do not match within a specific threshold, the user 140 may not pass the challenge and the user may be presented with another challenge depending on the settings of the social network server application 122. Upon passing the challenge, the user may be granted access to the resource.

FIG. 8 illustrates an interactive challenge involving playing a “mini-game” with the mobile device, in accordance with some embodiments. The figure shows the challenge 810 being presented on a user interface displayed on the display 310 of the mobile device 110. The challenge 810 displayed illustrates a “mini-game” that the user 140 can play or solve using motion of the mobile device 110. The specific “mini-game” requests the user to tilt their device at various angles such that the ball 820 falls within the hole 830 based on the tilt of the mobile device 110. The challenge 810 may be presented to the user 140 prior to granting the user 140 access to a resource, such as allowing the user post a content item or granting the user access to an account settings page as described above. Additionally, the challenge 810 may be presented to the user by the social network client application 115 after receiving a request from the social network server application 122 to do so. The specific challenge may be determined in the fashion described above with respect to FIGS. 1-2. While a mini-game that requests that the user move and tilt the mobile device 110 such that the ball 820 falls within the hole 830 is illustrated in the figure, any “mini-game” may be presented to the user 140 to play or solve using the mobile device 110.

In response to the presented challenge 810, the user 140 may move, angle, or otherwise tilt the mobile device 110 such that the ball 820 eventually rolls across the user interface of the display 310 and eventually falls within the hole 830. The accelerometer 113 along with another sensor such as a gyroscope may capture sensor data while the user is moving, angling, or tilting the mobile device 110 according to the “mini-game” presented. As described above, the captured sensor data may be compared to the challenge reference data 126a within the storage subsystem 126. The challenge reference data 126a may be accelerometer and gyroscope reference data indicative of moving, angling, or tilting the device according to the presented “mini-game” such that the ball 820 falls within the hole 830. If the captured sensor data and the challenge reference data 126a match within a specific threshold, the user 140 may pass the challenge. Otherwise, if the captured sensor data and the challenge reference data 126a do not match within a specific threshold, the user 140 may not pass the challenge and the user may be presented with another challenge depending on the settings of the social network server application 122. Upon passing the challenge, the user may be granted access to the resource. While the “mini-game” depicted in the figure illustrates rolling a ball 820 into a hole 830, any other type of “mini-game” may also be presented. For example, a “mini-game” may consist of having the user arrange a series of numbers in order by dragging the numbers across the user interface such that the numbers are ordered sequentially. There may be a vast number of possible “mini-games” presented as a challenge to the user 140.

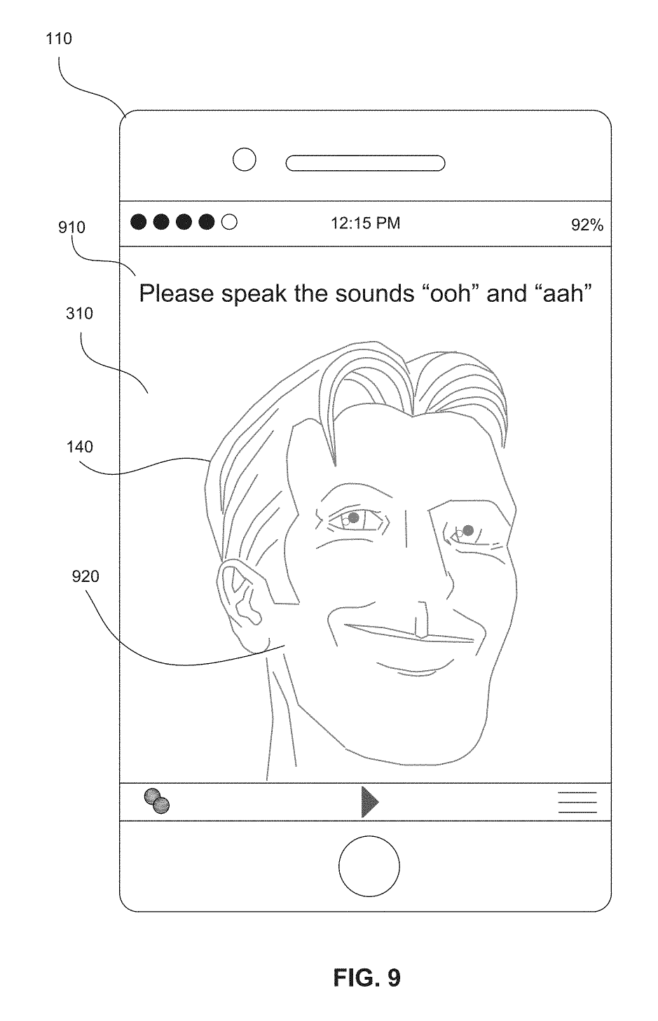

FIG. 9 illustrates an interactive challenge involving making a certain facial expression in front of a mobile device, in accordance with some embodiments. The figure shows the challenge 910 being presented on a user interface displayed on the display 310 of the mobile device 110. The challenge 910 displayed provides an instruction to the user 140 to speak certain sounds while the user's 140 face 920 is being captured by a camera of the mobile device 110. For example, the challenge instructs the user 140 to speak the sounds “ooh” and “aah” while the user's 140 face 920 is being captured by a camera part of the audio/video capture subsystem 117. The challenge 910 may be presented to the user 140 prior to granting the user 140 access to a resource, such as allowing the user post a content item or granting the user access to an account settings page as described above. Additionally, the challenge 910 may be presented to the user by the social network client application 115 after receiving a request from the social network server application 122 to do so. The specific challenge may be determined in the fashion described above with respect to FIGS. 1-2. While the instructions request the user to speak the sounds “ooh” and “aah” in the figure, any instruction that results in the user 140 making a facial expression in front of the camera of the mobile device 110 may be given to the user 140. For example, an the user 140 may be instructed to squint his/her eyes and may not require that the user speak any sound, but simply make the facial expression instructed.

In response to the presented challenge 910, the user 140 may speak the “ooh” and “aah” sounds while holding the mobile device 110 in such a position that the camera can capture the user's 140 face 920 while he/she makes the facial expression. A camera, part of the audio/video capture subsystem 117, may capture the user's face while the user is making the facial expression in accordance with the instructions provided by the challenge 910. The captured image/video data may be compared to the challenge reference data 126a within the storage subsystem 126. The challenge reference data 126a may be images/video of various human faces making the same “ooh” and “aah” sounds. In some embodiments, a classifier may be trained based on the challenge reference data 126a comprising the images/video of the facial expressions. The classifier may receive as an input the captured image/video of the user 140 and may output a class indicative of whether the user's facial expression is consistent with an “ooh” and “aah” sounds, in accordance with the classifier training. If the classifier outputs a class label indicative of the user's 140 facial expression consistent with making these sounds, the user 140 may pass the challenge. Otherwise, the user 140 may not pass the challenge and the user may be presented with another challenge depending on the settings of the social network server application 122. Upon passing the challenge, the user may be granted access to the resource.

In some embodiments, similar to what is described with respect to FIG. 9, the user 140 may be presented with a challenge that requests the user speak a phrase or sentence. For example, the user may be presented a challenge having instructions to speak “The weather is amazing today.” The user's 140 voice may be captured by a microphone of the mobile device 110. For example, the user may speak “The weather is amazing today” while the user's 140 voice may be captured by a microphone part of the audio/video capture subsystem 117. The captured audio data may be compared to the challenge reference data 126a within the storage subsystem 126. The challenge reference data 126a may be audio segments of various humans speaking the same or similar phrases. In some embodiments, a classifier may be trained based on the challenge reference data 126a comprising the audio segments of the human's speaking the same or similar phrases. The classifier may receive as an input the captured audio of the user 140, and/or attributes associated with the captured audio such as pitch, frequency, decibel, etc. and may output a class indicative of whether the user's voice is consistent with other human's voices, in accordance with the classifier training. If the classifier outputs a class label indicative of the user's 140 voice being a genuine human voice, the user 140 may pass the challenge. Otherwise, the user 140 may not pass the challenge and the user may be presented with another challenge depending on the settings of the social network server application 122. Upon passing the challenge, the user may be granted access to the resource.

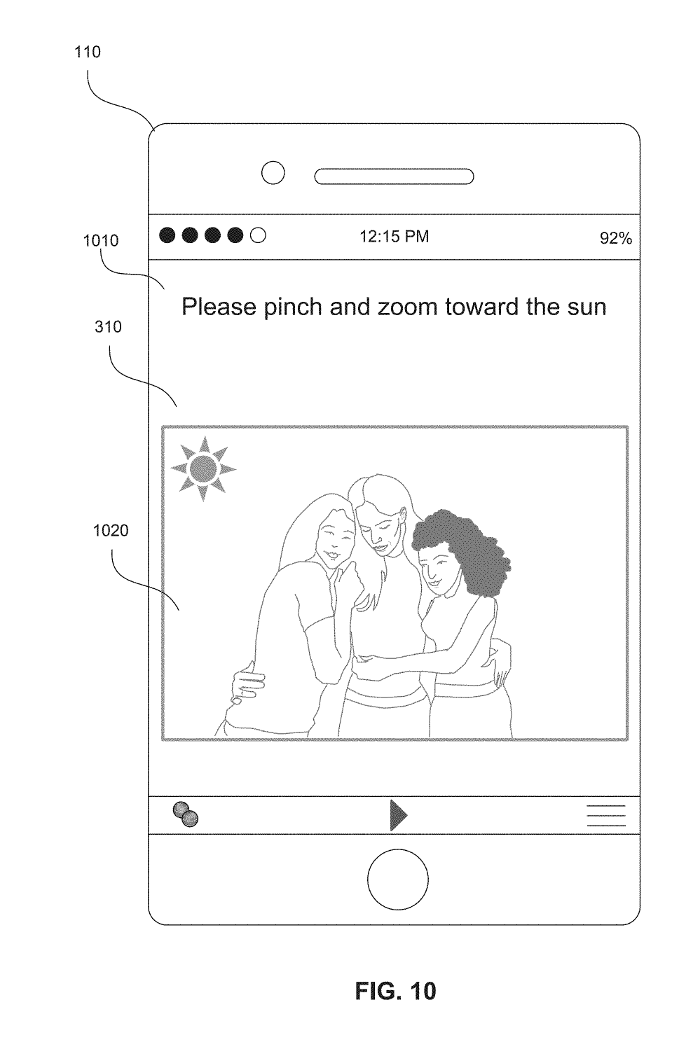

FIG. 10 illustrates an interactive challenge involving interactions with a presented image, in accordance with some embodiments. The figure shows the challenge 1010 being presented on a user interface displayed on the display 310 of the mobile device 110. The challenge 1010 displayed provides an instruction to the user 140 to pinch and zoom on the display 310 to zoom into or “blow-up” an object within a presented image 1020. For example, the challenge instructs the user 140 to zoom into the sun object within the presented image 1020. The challenge 1010 may be presented to the user 140 prior to granting the user 140 access to a resource, such as allowing the user post a content item or granting the user access to an account settings page as described above. Additionally, the challenge 1010 may be presented to the user by the social network client application 115 after receiving a request from the social network server application 122 to do so. The specific challenge may be determined in the fashion described above with respect to FIGS. 1-2. While the instructions request the user to zoom into the sun object within the presented image 1020, any instruction that results in manipulation of the image 1020 presented on the display 310 may be given to the user 140.

In response to the presented challenge 1010, the user 140 may pinch and zoom on the display 310 with his/her fingers such that the sun object is zoomed into on within the presented image 1020. The user may also “double-tap” on the display 310 to zoom into the sun object presented within the image 1020. The input subsystem 112 may capture sensor data while the user is interacting with the display 310 using his/her fingers. The captured sensor data, by the input subsystem 112, may include sensor data indicative of the user's gestures on the display 310. As described above, the captured sensor data may be compared to the challenge reference data 126a within the storage subsystem 126. The challenge reference data 126a may be gesture data that is indicative of natural gestures performed by humans on a display of a mobile device. The challenge reference data 126a may also include x-y coordinates of the object shown within the presented image 1020. If the captured sensor data and the challenge reference data 126a match within a specific threshold, the user 140 may pass the challenge. Otherwise, if the captured sensor data and the challenge reference data 126a do not match within a specific threshold, the user 140 may not pass the challenge and the user may be presented with another challenge depending on the settings of the social network server application 122. Upon passing the challenge, the user may be granted access to the resource.

While a “zoom into the object” type of challenge is shown in the figure, many other various challenges requiring the user to interact with a presented image may also be implemented. For example, an image may be presented at angle other than zero degrees with respect to a horizontal plane. The user may be requested to “rotate” the presented image using his/her fingers on the display 310 such that the image is brought back to, or close to, zero degrees with respect to the horizontal plane. In another example, a user may be requested to tap on a particular object within the image. The user's “tap” may be analyzed and compared against challenge reference data to determine whether the “tap” indicates a natural tap expected from a human user.

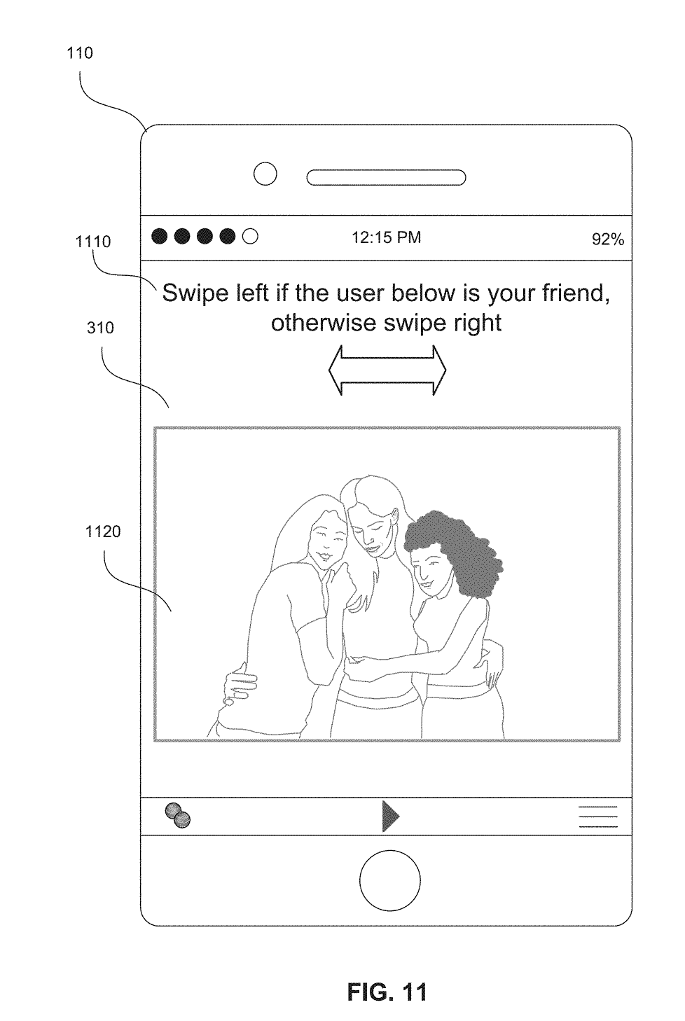

FIG. 11 illustrates another interactive challenge involving interactions with a presented image, in accordance with some embodiments. The figure shows the challenge 1110 being presented on a user interface displayed on the display 310 of the mobile device 110. The challenge 1110 displayed provides an instruction to the user 140 to swipe left if the user recognizes a person in a presented image 1120 that they are connected to within the social network environment, otherwise to swipe right if the user does not recognize the person in the image 1120. The challenge subsystem 124 may access a “friends list” of the user 140 to obtain profile images of other users that the user 140 is connected to within the social network environment and randomly present a profile image of one of the other users, or may present a random image of a person that the user is not connected to. The user 140 may swipe left if he/she recognizes the person in the image 1120, otherwise the user may swipe right. The challenge 1010 may be presented to the user 140 prior to granting the user 140 access to a resource, such as allowing the user post a content item or granting the user access to an account settings page as described above. Additionally, the challenge 1010 may be presented to the user by the social network client application 115 after receiving a request from the social network server application 122 to do so. The specific challenge may be determined in the fashion described above with respect to FIGS. 1-2.

If the user swipes in the correct direction based on the presented image 1120, the user 140 may not pass the challenge and the user may be presented with another challenge depending on the settings of the social network server application 122. Upon passing the challenge, the user may be granted access to the resource.

The challenge subsystems 116 and 124 together may perform the analysis of whether the captured sensor data compared to the challenge reference data 126a meets a threshold for passing the challenge, with respect to the descriptions in FIGS. 5-11. The result may be output to the social network server application 122. Similarly, the challenge subsystems 116 and 124 may invoke the classifiers in the examples above with respect to the descriptions in FIGS. 5-11.

Additionally, while numerous examples of interactive challenges are provided above, many other types of interactive challenges may also be presented. For example, a user may be requested to rest his finger on a fingerprint sensor part of the mobile device 110. The challenge subsystem 116 on the mobile device 110 may determine whether the fingerprint data is indicative of a human fingerprint in order for the user to pass the challenge. This determination may be performed on the mobile device 110 such that no fingerprint data may be sent to the server computer 120, preserving privacy of the user. In another embodiment, the user may be provided with a series of advertisements and may be requested to select the most relevant advertisement pertaining to a certain indicated product. For example, various advertisements may be presented to the user and the user may be requested to select an advertisement that best fits in line with an advertisement that would be typical of a brand of a soda beverage.

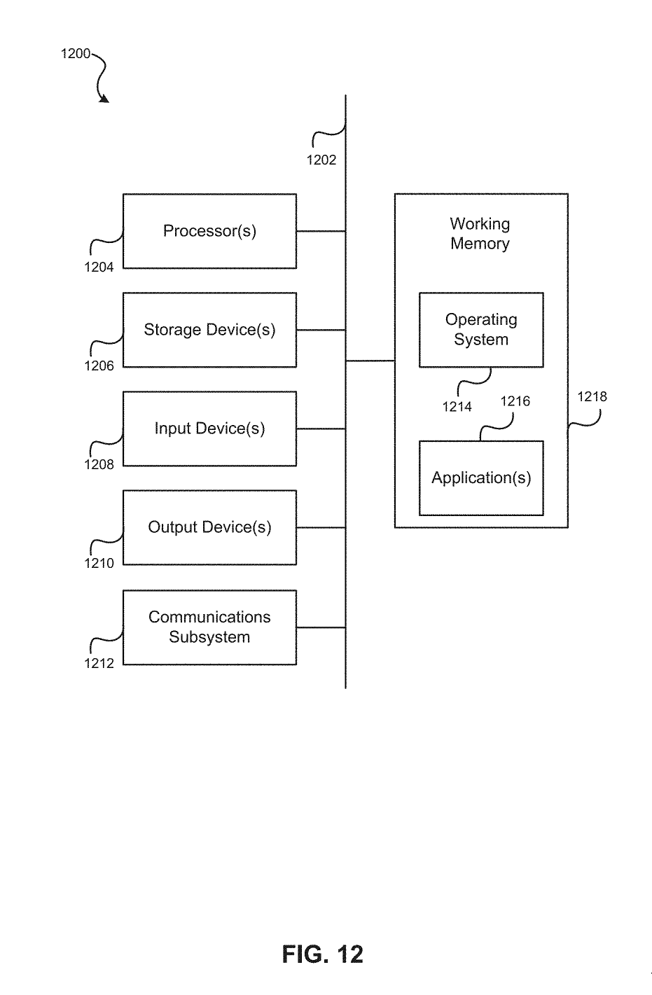

FIG. 12 illustrates an example of a computing system in which one or more embodiments may be implemented. A computer system as illustrated in FIG. 12 may be incorporated as part of the above described computerized device. For example, computer system 1200 can represent some of the components of a television, a computing device, a server, a desktop, a workstation, a control or interaction system in an automobile, a tablet, a netbook or any other suitable computing system. A computing device may be any computing device with an image capture device or input sensory unit and a user output device. An image capture device or input sensory unit may be a camera device. A user output device may be a display unit. Examples of a computing device include but are not limited to video game consoles, tablets, smart phones and any other hand-held devices. FIG. 12 provides a schematic illustration of one embodiment of a computer system 1200 that can perform the methods provided by various other embodiments, as described herein, and/or can function as the host computer system, a remote kiosk/terminal, a point-of-sale device, a telephonic or navigation or multimedia interface in an automobile, a computing device, a set-top box, a table computer and/or a computer system. FIG. 12 is meant only to provide a generalized illustration of various components, any or all of which may be utilized as appropriate. FIG. 12, therefore, broadly illustrates how individual system elements may be implemented in a relatively separated or relatively more integrated manner. In some embodiments, elements computer system 1200 may be used to implement functionality of mobile device 110 or server computer 120 in FIG. 1.

The computer system 1200 is shown comprising hardware elements that can be electrically coupled via a bus 1202 (or may otherwise be in communication, as appropriate). The hardware elements may include one or more processors 1204, including without limitation one or more general-purpose processors and/or one or more special-purpose processors (such as digital signal processing chips, graphics acceleration processors, and/or the like); one or more input devices 1208, which can include without limitation one or more cameras, sensors, a mouse, a keyboard, a microphone configured to detect ultrasound or other sounds, and/or the like; and one or more output devices 1210, which can include without limitation a display unit such as the device used in embodiments of the invention, a printer and/or the like.

In some implementations of the embodiments of the invention, various input devices 1208 and output devices 1210 may be embedded into interfaces such as display devices, tables, floors, walls, and window screens. Furthermore, input devices 1208 and output devices 1210 coupled to the processors may form multi-dimensional tracking systems.

The computer system 1200 may further include (and/or be in communication with) one or more non-transitory storage devices 1206, which can comprise, without limitation, local and/or network accessible storage, and/or can include, without limitation, a disk drive, a drive array, an optical storage device, a solid-state storage device such as a random access memory (“RAM”) and/or a read-only memory (“ROM”), which can be programmable, flash-updateable and/or the like. Such storage devices may be configured to implement any appropriate data storage, including without limitation, various file systems, database structures, and/or the like.

The computer system 1200 might also include a communications subsystem 1212, which can include without limitation a modem, a network card (wireless or wired), an infrared communication device, a wireless communication device and/or chipset (such as a Bluetooth™ device, an 802.11 device, a Wi-Fi device, a WiMax device, cellular communication facilities, etc.), and/or the like. The communications subsystem 1212 may permit data to be exchanged with a network, other computer systems, and/or any other devices described herein. In many embodiments, the computer system 1200 will further comprise a non-transitory working memory 1218, which can include a RAM or ROM device, as described above.

The computer system 1200 also can comprise software elements, shown as being currently located within the working memory 1218, including an operating system 1214, device drivers, executable libraries, and/or other code, such as one or more application programs 1216, which may comprise computer programs provided by various embodiments, and/or may be designed to implement methods, and/or configure systems, provided by other embodiments, as described herein. Merely by way of example, one or more procedures described with respect to the method(s) discussed above might be implemented as code and/or instructions executable by a computer (and/or a processor within a computer); in an aspect, then, such code and/or instructions can be used to configure and/or adapt a general purpose computer (or other device) to perform one or more operations in accordance with the described methods.

A set of these instructions and/or code might be stored on a computer-readable storage medium, such as the storage device(s) 1206 described above. In some cases, the storage medium might be incorporated within a computer system, such as computer system 1200. In other embodiments, the storage medium might be separate from a computer system (e.g., a removable medium, such as a compact disc), and/or provided in an installation package, such that the storage medium can be used to program, configure and/or adapt a general purpose computer with the instructions/code stored thereon. These instructions might take the form of executable code, which is executable by the computer system 1200 and/or might take the form of source and/or installable code, which, upon compilation and/or installation on the computer system 1200 (e.g., using any of a variety of generally available compilers, installation programs, compression/decompression utilities, etc.) then takes the form of executable code.

Substantial variations may be made in accordance with specific requirements. For example, customized hardware might also be used, and/or particular elements might be implemented in hardware, software (including portable software, such as applets, etc.), or both. Further, connection to other computing devices such as network input/output devices may be employed. In some embodiments, one or more elements of the computer system 1200 may be omitted or may be implemented separate from the illustrated system. For example, the processor 1204 and/or other elements may be implemented separate from the input device 1208. In one embodiment, the processor is configured to receive images from one or more cameras that are separately implemented. In some embodiments, elements in addition to those illustrated in FIG. 12 may be included in the computer system 1200.

Some embodiments may employ a computer system (such as the computer system 1200) to perform methods in accordance with the disclosure. For example, some or all of the procedures of the described methods may be performed by the computer system 1200 in response to processor 1204 executing one or more sequences of one or more instructions (which might be incorporated into the operating system 1214 and/or other code, such as an application program 1216) contained in the working memory 1218. Such instructions may be read into the working memory 1218 from another computer-readable medium, such as one or more of the storage device(s) 1206. Merely by way of example, execution of the sequences of instructions contained in the working memory 1218 might cause the processor(s) 904 to perform one or more procedures of the methods described herein.

The terms “machine-readable medium” and “computer-readable medium,” as used herein, refer to any medium that participates in providing data that causes a machine to operate in a specific fashion. In some embodiments implemented using the computer system 1200, various computer-readable media might be involved in providing instructions/code to processor(s) 1204 for execution and/or might be used to store and/or carry such instructions/code (e.g., as signals). In many implementations, a computer-readable medium is a physical and/or tangible storage medium. Such a medium may take many forms, including but not limited to, non-volatile media, volatile media, and transmission media. Non-volatile media include, for example, optical and/or magnetic disks, such as the storage device(s) 1206. Volatile media include, without limitation, dynamic memory, such as the working memory 1218. Transmission media include, without limitation, coaxial cables, copper wire and fiber optics, including the wires that comprise the bus 1202, as well as the various components of the communications subsystem 1212 (and/or the media by which the communications subsystem 1212 provides communication with other devices). Hence, transmission media can also take the form of waves (including without limitation radio, acoustic and/or light waves, such as those generated during radio-wave and infrared data communications).

Common forms of physical and/or tangible computer-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, EPROM, a FLASH-EPROM, any other memory chip or cartridge, a carrier wave as described hereinafter, or any other medium from which a computer can read instructions and/or code.

Various forms of computer-readable media may be involved in carrying one or more sequences of one or more instructions to the processor(s) 904 for execution. Merely by way of example, the instructions may initially be carried on a magnetic disk and/or optical disc of a remote computer. A remote computer might load the instructions into its dynamic memory and send the instructions as signals over a transmission medium to be received and/or executed by the computer system 1200. These signals, which might be in the form of electromagnetic signals, acoustic signals, optical signals and/or the like, are all examples of carrier waves on which instructions can be encoded, in accordance with various embodiments of the invention.

The communications subsystem 1212 (and/or components thereof) generally will receive the signals, and the bus 1202 then might carry the signals (and/or the data, instructions, etc. carried by the signals) to the working memory 1218, from which the processor(s) 1204 retrieves and executes the instructions. The instructions received by the working memory 1218 may optionally be stored on a non-transitory storage device 1206 either before or after execution by the processor(s) 1204.

The methods, systems, and devices discussed above are examples. Various embodiments may omit, substitute, or add various procedures or components as appropriate. For instance, in alternative configurations, the methods described may be performed in an order different from that described, and/or various stages may be added, omitted, and/or combined. Also, features described with respect to certain embodiments may be combined in various other embodiments. Different aspects and elements of the embodiments may be combined in a similar manner. Also, technology evolves and, thus, many of the elements are examples that do not limit the scope of the disclosure to those specific examples.

Specific details are given in the description to provide a thorough understanding of the embodiments. However, embodiments may be practiced without these specific details. For example, well-known circuits, processes, algorithms, structures, and techniques have been shown without unnecessary detail in order to avoid obscuring the embodiments. This description provides example embodiments only, and is not intended to limit the scope, applicability, or configuration of the invention. Rather, the preceding description of the embodiments will provide those skilled in the art with an enabling description for implementing embodiments of the invention. Various changes may be made in the function and arrangement of elements without departing from the spirit and scope of the invention.

Also, some embodiments are described as processes depicted as flow diagrams or block diagrams. Although each may describe the operations as a sequential process, many of the operations can be performed in parallel or concurrently. In addition, the order of the operations may be rearranged. A process may have additional steps not included in the figures. Furthermore, embodiments of the methods may be implemented by hardware, software, firmware, middleware, microcode, hardware description languages, or any combination thereof. When implemented in software, firmware, middleware, or microcode, the program code or code segments to perform the associated tasks may be stored in a computer-readable medium such as a storage medium. Processors may perform the associated tasks. Thus, in the description above, functions or methods that are described as being performed by the computer system may be performed by a processor—for example, the processor 1204—configured to perform the functions or methods. Further, such functions or methods may be performed by a processor executing instructions stored on one or more computer readable media.

Having described several embodiments, various modifications, alternative constructions, and equivalents may be used without departing from the spirit of the disclosure. For example, the above elements may merely be a component of a larger system, wherein other rules may take precedence over or otherwise modify the application of the invention. Also, a number of steps may be undertaken before, during, or after the above elements are considered. Accordingly, the above description does not limit the scope of the disclosure.

Various examples have been described. These and other examples are within the scope of the following claims.

1. A method, comprising:
receiving a request to provide a challenge, the request being generated in response to a determination that a content item attempted to be posted by a user of a mobile device to a social network environment meets a spam threshold, wherein the determination that the content item meets the spam threshold comprises applying a classifier to one or more attributes of the content item, wherein meeting the spam threshold indicates that the content item is likely being posted by a computer or robot for spam purposes rather than an actual human being, and wherein the classifier was trained based on one or more attributes of content before the attempt to post the content item;
presenting the challenge to the user in response to receiving the request to provide the challenge, the challenge requesting the user to make a specific sound;
capturing sensor data generated by one or more sensors associated with the mobile device as a result of one or more actions performed by the user in response to the challenge, the sensor data including at least one image showing an action performed by the user for making the specific sound;
determining whether the challenge was satisfied by comparing the sensor data to reference data stored in association with the challenge;
indicating whether the challenge was satisfied based at least in part on the determining; and
allowing the content item to be posted by the user to the social network environment upon determining that the challenge was satisfied.

2. (canceled)

3. The method of claim 1, wherein determining whether the challenge was satisfied comprises determining, based upon the sensor data, whether the mobile device is being held by a human.

4. (canceled)

5. (canceled)

6. The method of claim 1, wherein the indicating comprises providing an indication whether the challenge was satisfied to a source of the request to provide the challenge, wherein the request to provide the challenge is received from a social network application.

7. (canceled)

8. The method of claim 1, wherein the challenge is presented before allowing access to a resource, and wherein the method further comprises allowing access to the resource upon determining that the challenge was satisfied.

9. (canceled)

10. (canceled)

11. A mobile device, comprising:
a display;
a processor configured to receive a request to provide a challenge, the request being generated in response to a determination that a content item attempted to be posted by a user of the mobile device to a social network environment meets a spam threshold, wherein the determination that the content item meets the spam threshold comprises applying a classifier to one or more attributes of the content item, wherein meeting the spam threshold indicates that the content item is likely being posted by a computer or robot for spam purposes rather than an actual human being, and wherein the classifier was trained based on one or more attributes of content before the attempt to post the content item;
a challenge subsystem coupled to the processor, the challenge subsystem configured to present the challenge to the user in response to the processor receiving the request to provide the challenge, the challenge being presented via the display and requesting the user to make a specific sound;
one or more sensors coupled to the processor, the one or more sensors configured to generate sensor data as a result of one or more actions performed by the user in response to the challenge, the sensor data including at least one image showing an action performed by the user for making the specific sound,
wherein the processor is configured to:
determine whether the challenge was satisfied by comparing the sensor data to reference data stored in association with the challenge;
indicate whether the challenge was satisfied based at least in part on the determining; and
allow the content item to be posted by the user to the social network environment upon determining that the challenge was satisfied.

12. (canceled)

13. The mobile device of claim 11, wherein determining whether the challenge was satisfied comprises determining, based upon the sensor data, whether the mobile device is being held by a human.

14. (canceled)

15. (canceled)

16. The mobile device of claim 11, wherein the indicating comprises providing an indication whether the challenge was satisfied to a source of the request to provide the challenge, and wherein the request to provide the challenge is received from a social network application.

17. The mobile device of claim 11, wherein the challenge is presented before allowing access to a resource, and wherein the method further comprises allowing access to the resource upon determining that the challenge was satisfied.

18. (canceled)

19. (canceled)

20. One or more non-transitory computer-readable media storing computer-executable instructions that, when executed, cause one or more computing devices to:
receive a request to provide a challenge, the request being generated in response to a determination that a content item attempted to be posted by a user of a mobile device to a social network environment meets a spam threshold, wherein the determination that the content item meets the spam threshold comprises applying a classifier to one or more attributes of the content item, wherein meeting the spam threshold indicates that the content item is likely being posted by a computer or robot for spam purposes rather than an actual human being, and wherein the classifier was trained based on one or more attributes of content before the attempt to post the content item;
present a challenge to the user in response to receiving the request to provide the challenge, the challenge requesting the user to make a specific sound;
capture sensor data generated by one or more sensors associated with the mobile device as a result of one or more actions performed by the user in response to the challenge, the sensor data including at least one image showing an action performed by the user for making the specific sound;
determine whether the challenge was satisfied by comparing the sensor data to reference data stored in association with the challenge;
indicate whether the challenge was satisfied based at least in part on the determining; and
allow the content item to be posted by the user to the social network environment upon determining that the challenge was satisfied.

21. The method of claim 1, wherein the action includes performing a facial expression when making the specific sound, and wherein comparing the sensor data to the reference data includes comparing the at least one image to a reference image of a human face making the specific sound.

22. The method of claim 21, wherein comparing the sensor data to the reference data includes comparing the at least one image to a plurality of reference images of various human faces making the specific sound.

23. The method of claim 1, wherein the sensor data includes a video comprising the at least one image, the video showing the user's facial movements when making the specific sound, and wherein comparing the sensor data to the reference data includes comparing the video to a reference video of a human face making the specific sound.

24. The method of claim 1, further comprising:
presenting a second challenge to the user in response to determining that the challenge was not satisfied, the second challenge requesting the user to perform a specific action on the mobile device with respect to an object presented on a display of the mobile device.

25. The method of claim 24, wherein the specific action includes moving the mobile device to control the object during an interactive game presented on the display.

26. The method of claim 24, wherein the specific action includes zooming into the object by performing a pinch and zoom operation on the display.

27. The method of claim 24, further comprising:
selecting the object for presentation on the display, wherein the specific action includes swiping across the display in a first direction if the object is recognized by the user and swiping across the display in a second direction if the object is not recognized by the user; and
determining, based on whether or not the object should be recognized by the user, whether the user swiped in a correct direction.

28. The method of claim 1, further comprising:
presenting a second challenge to the user in response to determining that the challenge was not satisfied, the second challenge requesting the user to shake the mobile device according to a specific rhythm, the specific rhythm including a shake action and a pause action.

29. The mobile device of claim 11, wherein the action includes performing a facial expression when making the specific sound, and wherein comparing the sensor data to the reference data includes comparing the at least one image to a reference image of a human face making the specific sound.

30. The mobile device of claim 29, wherein comparing the sensor data to the reference data includes comparing the at least one image to a plurality of reference images of various human faces making the specific sound.

31. The mobile device of claim 11, wherein the sensor data includes a video comprising the at least one image, the video showing the user's facial movements when making the specific sound, and wherein comparing the sensor data to the reference data includes comparing the video to a reference video of a human face making the specific sound.

32. The mobile device of claim 11, wherein the challenge subsystem is further configured to present a second challenge to the user in response to the processor determining that the challenge was not satisfied, the second challenge requesting the user to perform a specific action on the mobile device with respect to an object presented on the display.

33. The mobile device of claim 32, wherein the specific action includes moving the mobile device to control the object during an interactive game presented on the display.

34. The mobile device of claim 32, wherein the specific action includes zooming into the object by performing a pinch and zoom operation on the display.

35. The mobile device of claim 32, wherein the challenge subsystem is configured to select the object for presentation on the display, wherein the specific action includes swiping across the display in a first direction if the object is recognized by the user and swiping across the display in a second direction if the object is not recognized by the user, and wherein the processor is configured to determine, based on whether or not the object should be recognized by the user, whether the user swiped in a correct direction.

36. The mobile device of claim 11, wherein the challenge subsystem is further configured to present a second challenge to the user in response to the processor determining that the challenge was not satisfied, the second challenge requesting the user to shake the mobile device according to a specific rhythm, the specific rhythm including a shake action and a pause action.

37. The method of claim 1, wherein the one or more attributes of the content item to which the classifier is applied include a post length.

38. The method of claim 1, further comprising:
displaying an option to appeal the determination that the content item meets the spam threshold, wherein the challenge is presented further in response to user selection of the option to appeal.
